(19) United States
(12) Patent Application Publication
(10) Pub. No.: US 2008/0052463 A1
(43) Pub. Date: Feb. 28, 2008

(54) Method and apparatus to implement cache-coherent network interfaces

(76) Inventors: Nagabhushan Chitlur, Portland, OR (US); Linda J. Rankin, Portland, OR (US); Paul M. Stillwell, Aloha, OR (US); Dennis R. Bradford, Portland, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/510,021

(22) Filed: Aug. 25, 2006

(51) Int. Cl. G06F 12/00

(52) U.S. Cl. 711/118

(57) ABSTRACT

A cache-coherent network interface includes registers or buffers addressable by a processor with reference to an address space of the processor. The processor and the cache-coherent network interface both share a common system bus. The registers or buffers are further cacheable into a cache of the processor with reference to the address space.

### TECHNICAL FIELD

This disclosure relates generally to electronic computing systems, and in particular but not exclusively, relates to network interfaces and cache coherency.

### BACKGROUND INFORMATION

FIG. 1 illustrates a Intel Hub Architecture (“IHA”) 100 for the 8xx family of chipsets. IHA 100 includes two hubs a memory controller hub (“MCH”) 105 and an input/output (“I/O”) controller hub (“ICH”) 110 linked via a hub interconnect 115. MCH 105 couples system memory 120 and a graphic unit 125 to a processor 130 via a front side bus (“FSB”) 135. ICH 110 couples a network interface card (“NIC”) 140, a data storage unit (“DSU”) 145, flash memory 150, universal serial bus (“USB”) ports 155, and peripheral component interconnect (“PCI”) ports 160 to MCH 105 via hub interconnect 115.

All communication between processor 130 and component devices coupled to ICH 110 must traverse ICH 110 (commonly referred to as the “south bridge”), hub interconnect 115, MCH 105 (commonly referred to as the “north bridge”), and FSB 135. ICH 110 and MCH 105 both introduce latency into data transfers to/from processor 130. Furthermore, since hub interconnect 115 is typically a considerably lower bandwidth interconnect than FSB 135 (e.g., FSB≅3.2 GB/s compared to hub interconnect≅266 MB/s), component devices coupled to ICH 110 have a relatively high latency, low bandwidth connection to processor 130 when compared to system memory 120. To compound this relatively high latency, low bandwidth disadvantage, ICH 110 adheres to strict ordering and fencing rules for transporting I/O operations via the PCI or PCIe standards. These ordering rules can be cumbersome and limiting.

Memory (i.e. device registers) on component devices is not cacheable by processor 130. Access to this uncacheable memory is low performance, due to the I/O issues described above. To transfer data using an I/O operation, data is moved to/from system memory, which acts as an intermediary, and then read by processor 130 or component devices (depending on the direction of the transfer) therefrom.

For example, conventional NICs (e.g., NIC 140) transmit data onto a network using the following technique. Processor 130 creates the data, transfers the data to system memory 120, generates descriptors pointing to the data in system memory 120, and posts the descriptors to a known location. Processor 130 then issues a “door bell” event to NIC 140 to notify NIC 140 that data awaits. In response, NIC 140 retrieves the descriptors and executes them to transfer the data from system memory 120 onto the network.

NIC 140 must also follow strict rules to write data received via the network to processor 130. First, processor 130 pre-posts a number of descriptors in a portion of system memory 120. When data arrives, NIC 140 automatically transfers the data into system memory 120 with reference to the pre-posted descriptors. Subsequently, NIC 130 issues an interrupt to processor 130 to notify processor 130 that new data is waiting in system memory 120 to be read-in by processor 130. Both of the receive and transmit operations of NIC 140 are relatively high latency events that incur substantial control signaling overhead that must be transported across ICH 110, MCH 105, and hub interconnect 115.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 (PRIOR ART) is a functional block diagram illustrating Intel Hub Architecture.

FIG. 2 is a functional block diagram illustrating a processor and a cache-coherent network interface sharing a system interconnect having cacheable memory internal to the cache-coherent network interface, in accordance with an embodiment of the invention.

FIG. 3 is a functional block diagram illustrating how cacheable memory internal to a cache-coherent network interface is accessible via memory apertures included within address space of a processor, in accordance with an embodiment of the invention.

FIG. 4 is a flow chart illustrating a process to transmit data over a network via a cache-coherent network interface, in accordance with an embodiment of the invention.

FIG. 5 is a flow chart illustrating a process to read data received from a network at a cache-coherent network interface, in accordance with an embodiment of the invention.

FIG. 6 is a block diagram illustrating a system implemented with cache-coherent network interfaces, in accordance with an embodiment of the invention.

### DETAILED DESCRIPTION

Embodiments of a system and method for a cache-coherent network interface are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

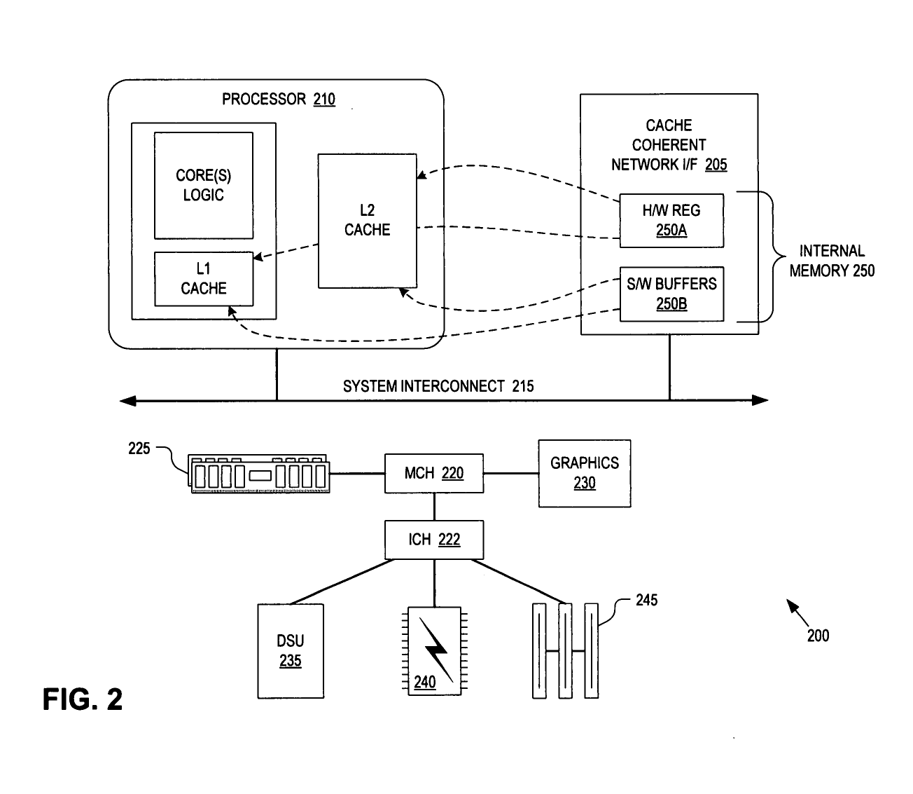

FIG. 2 is a functional block diagram illustrating a processing system 200 including a cache-coherent network interface (“CCNI”) 205 having internal cacheable memory, in accordance with an embodiment of the invention. The illustrated embodiment of processing system 200 includes CCNI 205, a processor 210, a system interconnect 215, a memory controller hub (“MCH”) 220, an input/output (“I/O”) controller hub (“ICH”) 222, system memory 225, a graphic unit 230, a data storage unit (“DSU”) 235, non-volatile (“NV”) memory 240, and various I/O ports 245 (e.g., USB, PCI, PCI-X, PCI-E, etc.).

Processor 210 and CCNI 205 both couple to and share system interconnect 215 as full participants on system interconnect 215. Since CCNI 205 couples to system interconnect 215 as a client thereof (does not couple via ICH 222) it is therefore addressable on system interconnect 215. Collaborating on system interconnect 215 as a full participant provides CCNI 205 with a high bandwidth, low latency direct link to processor 210. Since CCNI 205 is addressable on system interconnect 215, its internal hardware registers 250A and/or internal software buffers 250B (collectively internal memory 250) can be mapped into the system address space of processor 210. With internal memory 250 included in the memory map or address space of processor 210, processor 210 can then directly access (e.g., write to or read from) internal memory 250 without issuing interrupts or requests to a gate keeper or third party controller agent. In other words, internal memory 250 simply appears to be an extension of system memory 225, which processor 210 can read to or write from at will. Direct access to internal memory 250 enables processor 210 to quickly access data coming in from a network via CCNI 205 or checkup on internal control and status registers of CCNI 205 with very low latency. Internal memory 250 may be implemented as a variety of different cacheable memory types including write-back cacheable memory, write-through cacheable memory, write-combining cacheable memory, or the like.

Including internal memory 250 into the address space of processor 210 provides the added benefit that content stored in internal memory 250 can be cached into L1 cache or L2 cache of processor 210 as cacheable memory. Standard cache coherency mechanisms can be extended to ensure the cached copies of the content from internal memory 250 are kept up-to-date and valid within L1 cache or L2 cache. A cache coherency agent may be assigned to maintain this cache coherency. Accordingly, when data arrives from the network at CCNI 205, the cache coherency agent can invalid portions of the L1 or L2 cache, and transfer the data directly into the L1 or L2 cache for immediate access and processing by processor 210. The cache coherency agent may be implemented in a variety of manners including as a hardware entity in CCNI 205, a software driver executing on processor 210, firmware executing on a microcontroller internal to CCNI 105, a software application executing on processor 210, a kernel function of an operating system (“OS”) executing on processor 210, or some combination of these.

System interconnect 215 operates as a front side bus (“FSB”) of processing system 210 providing a coherent system interconnect for each client coupled thereto. A coherent system interconnect is a communication link that supports transport of cache coherency protocols there over. System interconnect 215 may be a high speed serial or parallel link. For example, in one embodiment system interconnect 215 is implemented with the Common System Interconnect (“CSI”) by Intel Corporation. In an alternative embodiment, system interconnect 215 is implemented with the HyperTransport (“HT”) interconnect by Advanced Micro Device, Inc.

In one embodiment, NV memory 240 is a flash memory device. In other embodiments, NV memory 240 includes any one of read only memory (“ROM”), programmable ROM, erasable programmable ROM, electrically erasable programmable ROM, or the like. In one embodiment, system memory 225 includes random access memory (“RAM”), such as dynamic RAM (“DRAM”), synchronous DRAM (“SDRAM”), double data rate SDRAM (“DDR SDRAM”), static RAM (“SRAM”), or the like. DSU 235 represents any storage device for software data, applications, and/or operating systems, but will most typically be a nonvolatile storage device. DSU 235 may optionally include one or more of an integrated drive electronic (“IDE”) hard disk, an enhanced IDE (“EIDE”) hard disk, a redundant array of independent disks (“RAID”), a small computer system interface (“SCSI”) hard disk, or the like. It should be appreciated that various other elements of processing system 200 may have been excluded from FIG. 2 and this discussion for the purposes of clarity.

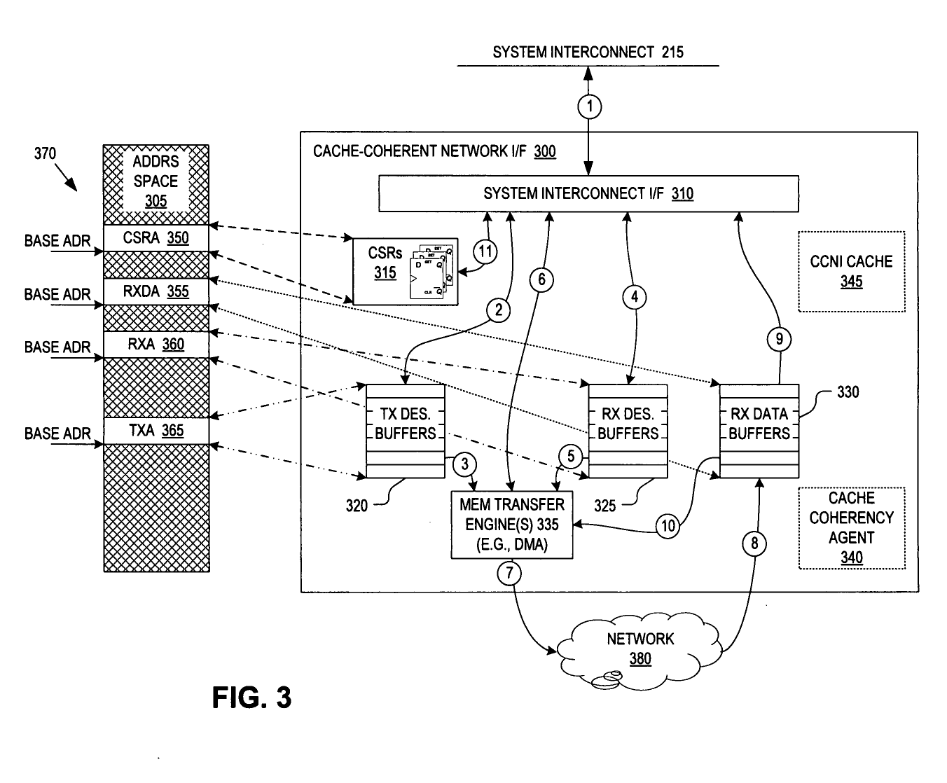

FIG. 3 is a functional block diagram illustrating how cacheable memory internal to a CCNI 300 is accessible via memory apertures included within an address space 305 of processor 210, in accordance with an embodiment of the invention. The illustrated embodiment of CCNI 300 includes a system interconnect interface 310, control and status registers (“CSRs”) 315, transmit (“TX”) descriptor buffers 320, receive (“RX”) descriptor buffers 325, RX data buffers 330, and a memory transfer engine(s) 335 (e.g., direct memory access (“DMA”) engine). CCNI 300 may further include a cache coherency agent 340, and a CCNI cache 345. The illustrated embodiment of CCNI 300 represents one possible embodiment of CCNI 205.

CSR Aperture (“CSRA”) 350, RX Data Aperture (“RXDA”) 355, RX Descriptor Aperture (“RXA”) 360, and TX Descriptor Aperture (“TXA”) 365 are coherent memory mapped apertures (collectively apertures 370) that expose their respective internal memory structures of CCNI 300 to software executing on processor 210. Each aperture 370 is backed by a corresponding hardware register 250A or software buffer 250B of internal memory 250. From the perspective of processor 210, apertures 370 look just like system memory 225 and are mapped as cacheable memory. Apertures 370 act as a sort of “window” into internal memory 250 and may be mapped anywhere within address space 305 of processor 210. In one embodiment, apertures 370 are regions of address space 305, each starting at a respective base address and continuing for a defined offset, that include pointers into their respective internal memory 250 locations. Writing to an aperture 370 will result in a change in the corresponding register/buffer of internal memory 250, while reading from an aperture 370 will return the latest contents of the corresponding register/buffer of internal memory 250. Access to internal memory 250 via apertures 370 may be implemented using standard cache control mechanisms.

Data transfer via apertures 370 is effected via a number of data paths within CCNI 300. All communication between processor 210 and CCNI 300 occurs via a data path (1), which physically traverses system interconnect 215 to system interconnect interface 310. A data path (2) enables processor 210 to directly write data or commands into TX descriptor buffers 320. TX descriptor buffers 320 are accessible via TXA 365. A data path (3) enables memory transfer engine(s) 335 to read data and/or commands (e.g., transmit descriptors) from TX descriptor buffers 320. A data path (4) enables processor 210 to directly write data and/or commands (e.g., receive descriptors) into RX descriptor buffers 325. RX descriptor buffers 325 are accessible via RXA 360. A data path (5) enables memory transfer engine(s) 335 to read data and/or commands (e.g., receive descriptors) to execute receive related functions on data currently buffered in RX data buffers 330. A data path (6) enables memory transfer engine(s) 335 to issue commands directly on system interconnect 215 as well as read/write data directly onto system interconnect 215. A data path (7) is the transmit path exiting CCNI 300 from memory transfer engine(s) 335 onto a network 380 (e.g., LAN, WAN, Internet, PC-to-PC direct link, etc.). A data path (8) is the receive path entering CCNI 300 from network 380 into RX data buffers 330. A data path (9) enables processor 210 to directly read or snoop data currently buffered in RX data buffers 330 and received from network 380. RX data buffers 330 are accessible to processor 210 via RXDA 355. A data path (10) enables memory transfer engine(s) 335 to read data from RX data buffers 330 and move it into system memory 225 directly on system interconnect 215. It is note worthy that while conventional NICs can move receive data into system memory, a conventional NIC cannot place the data directly on the high bandwidth, low latency FSB for transport to system memory 225. Rather, conventional NICs must transport the received data over a PCI bus via ICH 110 and adhere to cumbersome ordering rules. Finally, a data path (11) enables processor 210 to read/write directly to CSRs 315. CSRs 315 are accessible via CSRA 350.

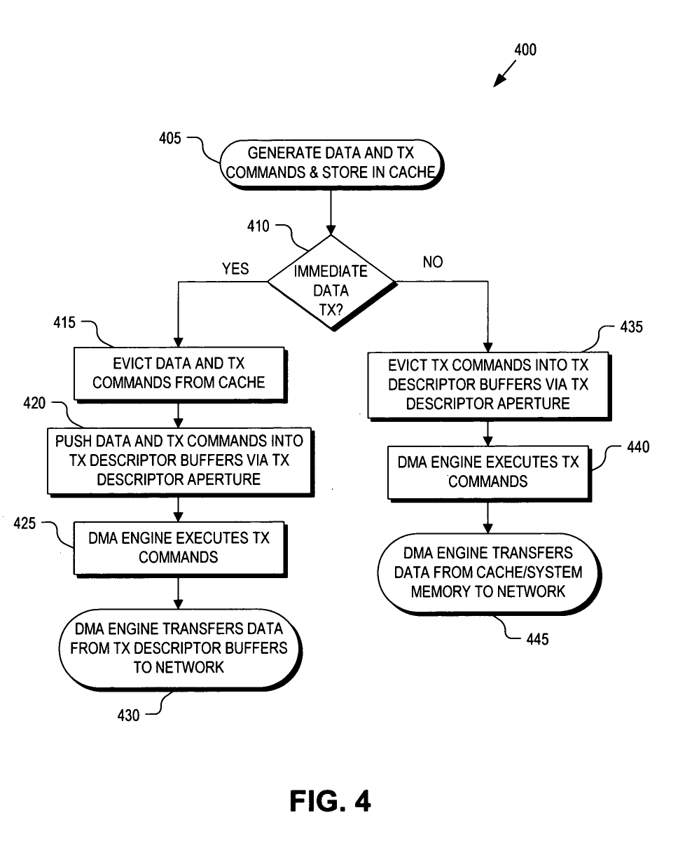

FIG. 4 is a flow chart illustrating a process 400 to transmit data over a network 380 via CCNI 300, in accordance with an embodiment of the invention. The order in which some or all of the process blocks appear in each process should not be deemed limiting. Rather, one of ordinary skill in the art having the benefit of the present disclosure will understand that some of the process blocks may be executed in a variety of orders not illustrated.

In a process block 405, processor 210 generates new data and transmit commands. The data and transmit commands may be initially created and stored in L1 or L2 cache of processor 210. If the data transfer is intended to be an “immediate data transfer” (decision block 410), then process 400 continues to a process block 415. An immediate data transfer is a type of zero copy transfer where the data to be transmitted is not first written into system memory 225.

In process block 415, the transmit commands and the data are evicted from the L1 or L2 cache of processor 210. The evicted transmit commands and data are written into TX descriptor buffers 320 of CCNI 300 through TXA 365 along data paths (1) and (2) (process block 420). In a process block 425, memory transfer engine(s) 335 access the transmit commands (e.g., transmit descriptors) in TX descriptor buffers 320 along data path (3) and executes the transmit commands. In a process block 430, memory transfer engine(s) 335 transfers the data also buffered in TX descriptor buffers 320 onto network 380 along data path (7) in response to executing the transmit commands.

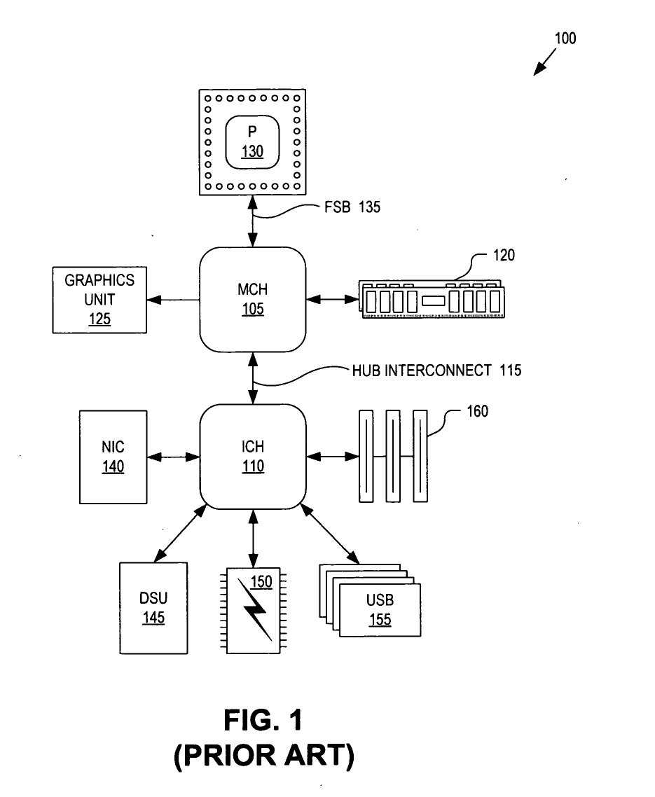

Returning to decision block 410, if the data transfer is not an immediate data transfer, then process 400 continues to a process block 435. In a process block 435, the transmit commands are evicted or pushed into TX descriptor buffers 320 along data paths (1) and (2). Again, the transmit commands are pushed into TX descriptor buffers 320 through TXA 365. In a process block 440, memory transfer engine(s) 335 accesses TX descriptor buffers 320 along data path (3) to retrieve and execute the transmit commands (process block 445). In this case, the transmit commands include DMA transfer commands to DMA fetch the data from L1 or L2 cache (or system memory 225 if the data has been evicted from L1 and L2 cache into system memory 225) and push it onto network 380 along data paths (1), (6), and (7). It should be appreciated that the DMA transfers from L1 or L2 cache (or system memory 225) are transferred across system interconnect 215 (not a PCI or PCI-Express bus), and therefore are considerably faster than compared to a DMA transfer by NIC 140 in FIG. 1.

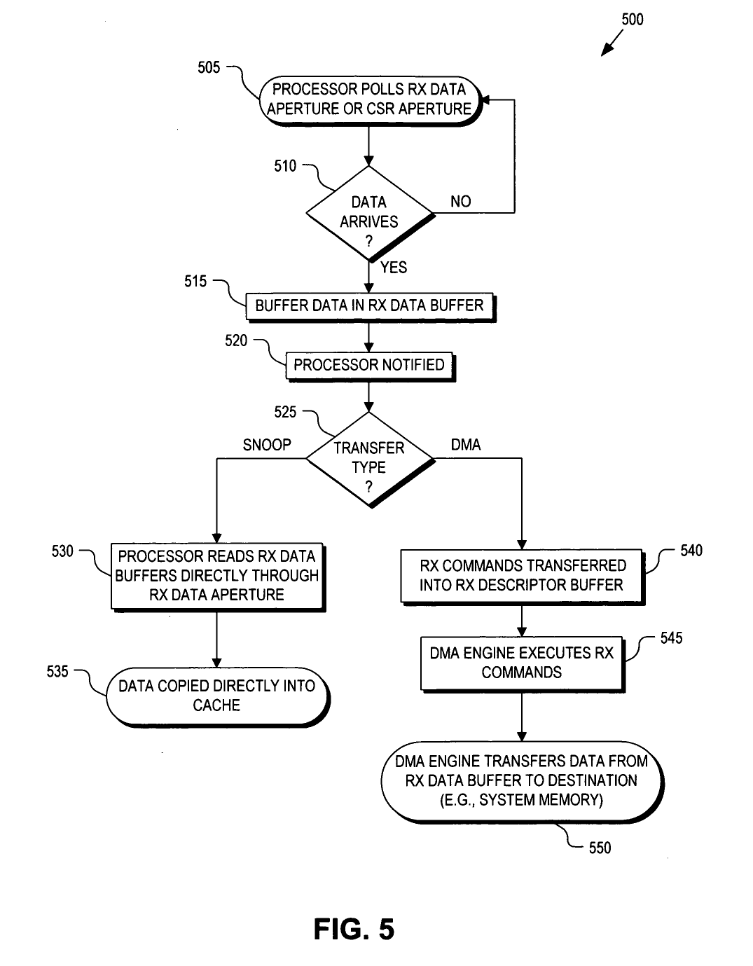

FIG. 5 is a flow chart illustrating a process 500 to read data received from network 380 at CCNI 300, in accordance with an embodiment of the invention. In a process block 505, processor 210 commences polling or “snooping” RX data buffers 330 via RXDA 355 to determine if new data has arrived from network 380. Processor 210 polls RX data buffers 330 along data paths (1) and (9). In one embodiment, as data arrives in RX data buffers 330, CCNI 300 updates CSRs 315 to indicate that new data has arrived. In this embodiment, processor 210 may alternatively or additionally poll CSRs 315 via CSRA 350 to determine whether new data has arrived.

When data arrives over network 380 via data path (8) (decision block 510), the data is buffered into RX data buffers 330 (process block 515). In a process block 520, processor 210 is notifed of the new data in response to a polling event. In one embodiment, when the new data arrives in RX data buffers 330, cache coherency agent 340 invalidates the cache of processor 210, which is identified by the polling event, indicating that the data in RX data buffers 330 has changed. In other embodiments, processor 210 does not continuously poll RXDA 355 for new data; rather, an interrupt event may be issued by CCNI 300 directly onto system interconnect 215 to notify processor 210. Accordingly, using the event driven interrupt mechanism, process block 505 is not executed.

Once processor 210 becomes aware of the new data in RX data buffers 330, there are multiple transfer types or techniques by which processor 210 may retrieve the data. In decision block 525, if the transfer is a zero-copy snoop transfer, then process 500 continues to a process block 530. A zero-copy snoop transfer is referred to as a “zero-copy transfer” because the data is copied directly into L1 or L2 cache by processor 210 without first copying the received data into system memory 225. A zero-copy snoop transfer is referred to as a “snoop transfer” because the transfer is initiated when processor 210 directly snoops into RX data buffers 330 to determine whether new data has arrived, as opposed to receiving an interrupt event.

In a process block 530, processor 210 reads the data directly from RX data buffers 330 through RXDA 355 along data paths (1) and (9), and then enrolls or copies the received data directly into the L1 or L2 cache (process block 535) for immediate consumption.

Returning to decision block 525, if the transfer mechanism is to be a DMA transfer, then process 500 proceeds to a process block 540. In process block 540, receive commands (e.g., receive descriptors) are transferred into RX descriptor buffers 325 via data paths (1) and (4). In one embodiment, processor 210 pushes the receive commands into RX descriptor buffers 325 via RXA 360. In a process block 545, memory transfer engine(s) 335 accesses the receive commands along data path (5) for execution. In response to the received commands, memory transfer engine(s) 335 fetches the received data from RX data buffers 330 along data path (10) and transfers the received data into system memory 225 via system interconnect 215 along data paths (6) and (1).

In one embodiment, CCNI 300 includes and maintains its own internal CCNI cache 345. CCNI cache 345 is accessible to processor 210 in a similar manner to system memory 225 and viewed by processor 210 simply as an extension of its system memory 225. In this embodiment, both received and transmit data may be cached locally by CCNI 300. For example, data received from network 380 may be cached locally for direct access by processor 210 therefrom. Data to be transmitted may be written into CCNI cache 345 by processor 210 with corresponding transmit descriptors written into TX descriptor buffers 320. Subsequently, when memory transfer engine 335 executes the transmit descriptor, memory transfer engine(s) 335 may pull the data directly from the local CCNI cache 345.

Directly coupling CCNI 300 to processor 210 over a cache coherent system interconnect enables processor 210 to directly and efficiently read network data received at CCNI 300 in any manner it chooses. Rather than having to adhere to strict ordering and fencing rules required for transfers over PCI or PCI-Express, the cacheable memory of CCNI 300 enables a host of technologies like software controlled zero-copy receive, software based packet splitting, and software based out of order packet processing. CCNI 300 enables processor 210 to directly peer into internal memory 250 to obtain control and status data at will and directly manage the resources of its network interface.

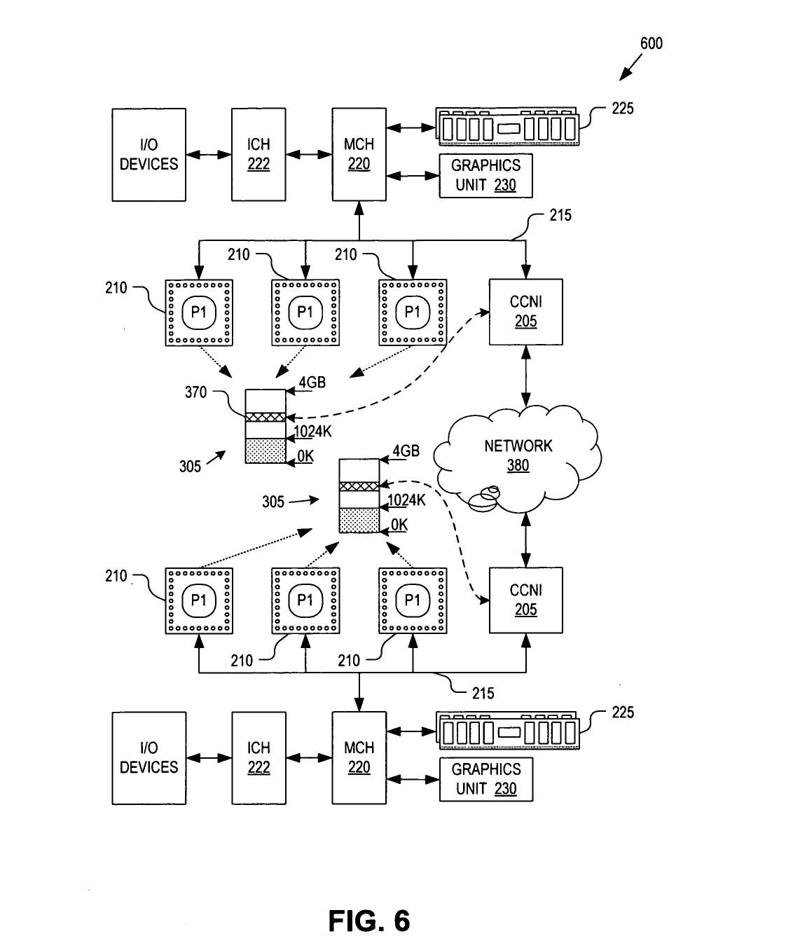

FIG. 6 is a block diagram illustrating a system 600 implemented with CCNIs 205, in accordance with an embodiment of the invention. FIG. 6 illustrates how a CCNI 205 can share a single system interconnect 215 with multiple processors (e.g., three) by implementing cache coherent mechanism across system interconnect 215 with each processor 210.

As illustrated, each processor 210 maintains an address space 305 which include apertures 370 for accessing a CCNI 205 sharing the same system interconnect 215. CCNIs 215 are full participants with processors 210 on their respective system interconnects 215. Although the illustrated system interconnects 215 assume a multi-drop front side bus configuration, other configurations with point-to-point interfaces between processors 210 and CCNI 205, with or without integrated memory controllers, may be implemented, as well.

Sharing a single coherent system interconnect, such as system interconnect 215, between CCNI 205 and multiple processors 210, enables assigning one or more processors 210 to specialized tasks to preprocess packets arriving or departing on network 380. For example, packets arriving at CCNI 205 may be initially cached by a first one of processors 210 who is assigned the task of decompression and/or decryption, then evicted into the cache of another one of processors 210 executing a software application consuming the data. In the outgoing direction, one of processors 210 may be assigned the task of compressing and/or encrypting data generated by a second one of processors 210, prior to transferring the data over system interconnect 215 to CCNI 205 for transmission onto network 380.

The processes explained above are described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM), random access memory (RAM), magnetic disk storage media, optical storage media, flash memory devices, etc.), as well as electrical, optical, acoustical or other forms of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method, comprising:
addressing registers or buffers of a network interface within address space of a processor; and
caching content in the registers or buffers into a cache of the processor with reference to the address space of the processor.

2. The method of claim 1, wherein the network interface is coupled to and addressable on a system bus of the processor, and wherein caching the content comprises transferring the content from the registers or buffers into the cache without first transferring the content to system memory of the processor.

3. The method of claim 2, wherein the network interface comprises a cache-coherent network interface and the registers or buffers comprise cacheable memory addressed in the address space of the processor.

4. The method of claim 3, wherein the registers or buffers include at least one of a control and status registers (“CSRs”), transmit descriptor buffers, receive descriptor buffers, or receive data buffers, wherein:
the CSRs are accessible to the processor via a CSR aperture included in an address map of the processor,
the transmit descriptor buffers are accessible to the processor via a transmit descriptor aperture included in the address map of the processor,
the receive descriptor buffers are accessible to the processor via a receive descriptor aperture included in the address map of the processor, and
the receive data buffers are accessible to the processor via a receive data aperture included within the address map of the processor.

5. The method of claim 1, further comprising:
receiving data from a network at the network interface;
buffering the data at the network interface in a receive data buffer; and
reading the data from the receive data buffer into the cache under control of the processor by addressing the receive data buffer with reference to the address space of the processor.

6. The method of claim 1, further comprising:
creating a command in the cache of the processor; and
evicting the command from the cache into a descriptor buffer physically located in the network interface, wherein the descriptor buffer is addressable via the address space of the processor.

7. The method of claim 6, wherein the descriptor buffer comprises a receive descriptor buffer, the method further comprising:
buffering data received from a network coupled to the network interface in a receive data buffer;
executing the command from the receive descriptor buffer with a direct memory access (“DMA”) engine of the network interface, and
transferring the data buffered in the receive data buffer onto a front side bus of the processor coupled to the network interface under control of the DMA engine in response to executing the command.

8. The method of claim 6, wherein the descriptor buffer comprises a transmit descriptor buffer, the method further comprising:
transferring data from the cache into the transmit descriptor buffer;
executing the command from the transmit descriptor buffer with a memory transfer engine of the network interface; and
transmitting the data in the transmit descriptor buffer onto the network under control of the memory transfer engine in response to executing the command.

9. The method of claim 1, further comprising:
caching control and status register (“CSR”) content of the network interface in the cache of the processor;
invalidating a portion of the cache caching the CSR content when the CSR content changes; and
updating the cache when with new CSR content when the CSR content changes.

10. An apparatus, comprising:
a system bus;
a processor coupled to the system bus, the processor including a cache; and
a network interface coupled to the system bus, the network interface including registers or buffers addressable by the processor via an address space of the processor.

11. The apparatus of claim 10, wherein the network interface is addressable on the system bus.

12. The apparatus of claim 11, wherein the network interface comprises a cache-coherent network interface and the registers or buffers comprise cacheable memory addressed in the address space of the processor and cacheable in the cache of the processor.

13. The apparatus of claim 11, wherein the network interface is coupled to the system bus to cache content of the registers or buffers in the cache of the processor, the apparatus further comprising:
a cache coherency agent coupled to maintain cache coherency between the cache of the processor and the registers or buffers.

14. The apparatus of claim 10, wherein the registers or buffers of the network interface include a receive data buffer to buffer network data received from a network and a receive descriptor buffer coupled to buffer receive commands written from the processor, the apparatus further comprising:
a memory transfer engine coupled to the receive descriptor buffer and to the receive data buffer to execute the receive commands buffered in the receive descriptor buffer and to direct memory access (“DMA”) transfer the network data into system memory of the processor in response to the receive commands, wherein the memory transfer engine transmits the network data directly onto the system bus.

15. The apparatus of claim 14, wherein the registers or buffers of the network interface further includes a transmit descriptor buffer coupled to the memory transfer engine, the transmit descriptor buffer coupled to buffer immediate data and transmit commands, the memory trasnfer engine coupled to transmit the immediate data onto the network in response to executing the transmit commands, wherein the processor is coupled to write the immediate data and the transmit commands into the transmit descriptor buffer without first transferring the immediate data and the transmit commands into the system memory.

16. The apparatus of claim 10, wherein the registers or buffers of the network interface include control and status registers addressable by the processor via the address space of the processor.

17. The apparatus of claim 10, wherein the network interface comprises a network interface card (“NIC”) and the system bus comprises one of a front side bus, a HyperTransport interconnect, or a Common System Interconnect (“CSI”).

18. The apparatus of claim 10, wherein the network interface further includes an internal cache for caching data received from a network, wherein the cache is accessible to the processor as an extension of system memory.

19. A system, comprising:
a system interconnect;
synchronous dynamic random access memory (“SDRAM”) linked to the system interconnect, the SDRAM to store instructions;
a processor coupled to the system interconnect to receive and execute the instructions; and
a network interface coupled to the system interconnect, the network interface including registers or buffers addressable by the processor via an address space of the processor.

20. The system of claim 19, wherein the network interface comprises a cache-coherent network interface card (“NIC”) addressable on the system bus and wherein the registers or buffers of the cache-coherent NIC comprise cacheable memory addressed in the address space of the processor.

21. The system of claim 20, wherein the cache-coherent NIC is coupled to the system interconnect to cache content of the registers or buffers in a cache of the processor, the system further comprising:
a cache coherency agent coupled to maintain cache coherency between the cache of the processor and the registers or buffers.

22. The system of claim 19, wherein the registers or buffers of the network interface include control and status registers addressable by the processor via the address space of the processor.

23. The system of claim 19, further including a plurality of processors coupled to the system interconnect, wherein the registers or buffers of the network interface are addressable by each of the plurality of processors via their respective address spaces.
